(19) United States
(12) Patent Application Publication
(10) Pub. No.: US 2010/0175761 A1
(43) Pub. Date: Jul. 15, 2010

(54) Mounting plate

(75) Inventor: Werner SCHLUETER, Iserlohn (DE)

Correspondence Address: COLLARD & ROE, P.C., 1077 NORTHERN BOULEVARD, ROSLYN, NY, 11576, US

(73) Assignee: Schlueter-Systems KG

(21) Appl. No.: 12/655,941

(22) Filed: Jan. 11, 2010

(30) Foreign Application Priority Data
Jan. 12, 2009 (EP) 09 000 273.4

(51) Int. Cl. F16L 5/00

(52) U.S. Cl. 137/362

(57) ABSTRACT

A mounting plate 10 for the laying of a floor drain which has at least one drain housing and a drain pipe to be connected to the latter, comprising a pre-fabricated housing recess 24 for accommodating the drain housing and at least one pre-fabricated pipe channel 26, 28; 42, 44 extending from the housing recess 24 for accommodating the drain pipe, the at least one pipe channel 26, 28; 42, 44 being open at least partially on just one side.

The present invention relates to mounting plates for the laying of floor drains which are used, for example, when installing floors in shower cubicles or when producing floor surfaces with water drainage.

These types of mounting plate are already known from the prior art. One can basically distinguish between mounting plates which are first and foremost used to accommodate a drain housing and a drain pipe of a floor drain, and mounting plates which are primarily used to produce an incline towards a drain opening of the floor drain, both mounting plates often being used together.

Mounting plates of the first specified type are normally used whenever a drain housing with a drain to the side and a drain pipe to be connected to the latter can not be sunk into the available substrate. In the simplest of cases this type of mounting plate is produced on site during fitting by a housing recess for accommodating the drain housing and a pipe channel extending from the housing recess for accommodating the drain pipe being sawn or cut, mainly centrally, into a level plate. However, manual production of the housing recess and of the pipe channel requires a lot of time. Furthermore, the waste produced during assembly must be disposed of. Moreover, there is the risk that the mounting plate will be cut incorrectly so that the latter becomes totally unusable. Also, a manual, precisely fitting cut of the housing recess is scarcely possible, in particular for flush accommodation of the drain housing flange.

In order to resolve this problem a mounting plate 100 according to FIG. 4 is known which is marketed in a similar form, for example, by the company LUX ELEMENTS GmbH & Co. KG. With this mounting plate 100 a square housing recess 102, open on both sides, for accommodating the drain housing, and a pipe channel 104 for accommodating the drain pipe, extending from the housing recess 102 and open on both sides, is already pre-fabricated so that sawing or cutting on site can be dispensed with. The fitting complexity is correspondingly reduced. However, there is the disadvantage that the strength of the mounting plate 100 is greatly reduced due to the pre-fabricated pipe channel 104. Correspondingly, the mounting plate 100 may be slightly damaged, in particular before being fitted. Moreover, the pre-fabricated pipe channel 104 can not be used if the drain pipe of the floor drain is to be taken diagonally from the housing recess 102. In this case a mounting plate with a pre-fabricated diagonal pipe channel is required. Alternatively, a diagonal pipe channel could of course also be sawn or cut into the mounting plate 100 shown in FIG. 4. However, the result of this would inevitably be that the mounting plate 100 would be split in two parts, and this is not desirable in relation to the fitting and, if applicable, in relation to the stability of the mounting plate 100 in the fitted state. A further disadvantage is that the square housing recess 102 can not accommodate the drain housing to be disposed therein with a precise fit. Therefore, correct pre-positioning of the drain housing during fitting is only possible under certain circumstances. Furthermore, the mounting plate 100 is very cumbersome, and correspondingly difficult to handle, in particular to transport.

It is an object of the present invention to provide a mounting plate for the laying of at least one drain housing and a floor drain having a drain pipe to be connected to the latter which at least partially eliminates the problems specified at the start.

In order to achieve this object the present invention provides a mounting plate of the type specified comprising a pre-fabricated housing recess for accommodating the drain housing, the dimensions and/or contour of which are advantageously matched to those of the drain housing to be accommodated therein, and at least one pre-fabricated pipe channel extendin from the housing recess for accommodating the drain pipe, the at least one pipe channel being open at least partially on just one side.

Due to the fact that in at least one region the at least one pipe channel does not extend over the whole mounting plate thickness, the strength of the plate in comparison to a mounting plate with a continuous pipe channel open on both sides is substantially increased so that damage to the mounting plate caused by the pipe channel can largely be prevented. Moreover, if required, the pipe channel can be reinforced or strengthened by providing at least one strengthening rib.

A number of pre-fabricated pipe channels extending in different directions can also be provided without cutting through the mounting plate, as would be the case when using pipe channels open on both sides. In this way the mounting plate can be used variably.

The height of a pipe channel open on just one side, which is reduced in comparison to a pipe channel open on both sides, is insignificant in most applications because the thickness of the mounting plate is normally dependent upon the higher structure of the drain housing, and so also in the case of a pipe channel only open on one side, in most cases sufficient space remains for laying the drain pipe.

In response, the housing recess is preferably designed to be open on both sides, by means of which its height can be maximized and the total thickness of the mounting plate can be minimized.

On the upper side of the mounting plate an annular indentation enclosing the housing recess and for accommodating a support flange of the drain housing is preferably provided so that the upper side of the support flange ends substantially flush with the upper side of the mounting plate. Furthermore, by means of the indentation, the support flange can be accommodated with a precise fit, and so pre-determined positioning of the drain housing can be achieved.

According to one embodiment of the mounting plate according to the invention, the at least one pipe channel has a channel section extending from the housing recess, open on both sides, the length of which can advantageously have dimensions such that a connection point between the drain housing and the drain pipe is exposed and is correspondingly easily accessible. On the one hand, in this way fitting is facilitated. On the other hand the connection point is normally thicker than the other drain pipe diameter, and this is why more space needs to be provided for accommodating the connection point.

If a number of pipe channels are provided, adjacent pipe channels are advantageously disposed at an angle of 90° or less, in particular approximately 45°, in relation to one another so that with a rectangular mounting plate a pipe channel extends along the mounting plate diagonals.

In the event that the height of a channel section only open on one side is insufficient for accommodating specific drain pipes, the pipe channel sections only open on one side can of course be sawn or cut free. For this purpose cutting guidelines and/or cutting guide indentations are preferably provided in order to facilitate manual cutting free.

According to one embodiment of the present invention the mounting plate has a polygonal, for example rectangular, outer contour. If instead of the polygonal outer contour a different outer contour is desired, such as for example a round or elliptical outer contour, the mounting plate can be brought into the desired shape by means of sawing or cutting. For this purpose cutting guide lines and/or cutting guide indentations are advantageously provided in order to facilitate manual cutting out of an outer contour different from the rectangular outer contour, in particular of a round or elliptical outer contour.

Preferably, at least one surface of the mounting plate is provided with adhesion-promoting means which support adhesion and/or clinging of a mortar or adhesive to the surface. In particular, indentations or projections can be formed on the at least one surface of the mounting plate as adhesion-promoting means.

According to a further embodiment of the present invention the mounting plate is split into a number of separate mounting plate segments, in particular into two mounting plate segments. This splitting of the mounting plate into segments facilitates handling, in particular transportation and also packaging.

Preferably, the mounting plate segments have substantially the same dimensions. In this way in particular the packaging of the mounting plate segments is facilitated.

The mounting plate segments can also be designed identically. The same tools can be used for the production of the mounting plates, and so production costs are low.

Alternatively just one of the mounting plate segments has one or more pipe channels. In this way in particular the overall strength of the mounting plate is prevented from being reduced too greatly.

The abutting surfaces of the mounting plate segments are preferably provided with connection means which serve to attach adjacent mounting plate segments to one another, the connection means preferably engaging with one another with a form fit. For this purpose dovetail-shaped projections, for example, can engage in dovetail-shaped recesses.

Preferably, the mounting plate is made at least partially of a solid foam, in particular polystyrene, since both during production (in particular due to its easy shaping, the adjustability of its density and so the strength of the mounting plate, etc) and during subsequent fitting (solid foam can easily be cut, sawn, etc.) solid foam can be handled very easily.

Furthermore, the present invention provides a mounting plate set comprising at least one mounting plate of the type described above, and at least one second mounting plate which has a pre-fabricated passage opening for accommodating a component of the floor drain, designed like a pipe, and an upper side provided with an incline towards the passage opening.

The second mounting plate is preferably split into a number of separate mounting plate segments, in particular into two mounting plate segments. The splitting of the second mounting plate into a number of segments leads, as already explained, in particular to the mounting plate being more easy to handle and transport. The mounting plate segments can have substantially the same dimensions by means of which the packaging of the mounting plate is facilitated. Furthermore, the mounting plate segments can be designed identically, by means of which production costs are kept low. In order to attach adjacent mounting plate segments to one another, the abutting surfaces of the mounting plate segments can, moreover, be provided with connection means, in particular with connection means engaging with one another with a force fit. At least one surface of the mounting plate can also be provided with adhesion-promoting means which support adhesion and/or clinging of a mortar or adhesive onto the upper side, in particular in the form of indentations or projections which are formed on the surface of the mounting plate. Furthermore, the upper side of the second mounting plate can be provided with a sealing material, for example in the form of a strip-shaped material which is attached to the upper side of the second mounting plate, or in the form of a coating material which is applied to the upper side of the second mounting plate. Correspondingly, penetration of moisture is reliably prevented. Moreover, on its upper side, the second mounting plate is preferably provided with an annular indentation which surrounds the passage opening and serves to accommodate an annular support flange of a further component of the floor drain system. On the surface of the annular indentation ribs can be formed which during fitting support the formation of a defined mortar layer thickness. Preferably, the mounting plate is made at least partially of solid foam, in particular polystyrene, because solid foam can be handled very easily.

With regard to further advantageous embodiments of the invention, reference is made to the sub-claims and to the following description of different exemplary embodiments with reference to the attached drawings. The drawings show as follows:

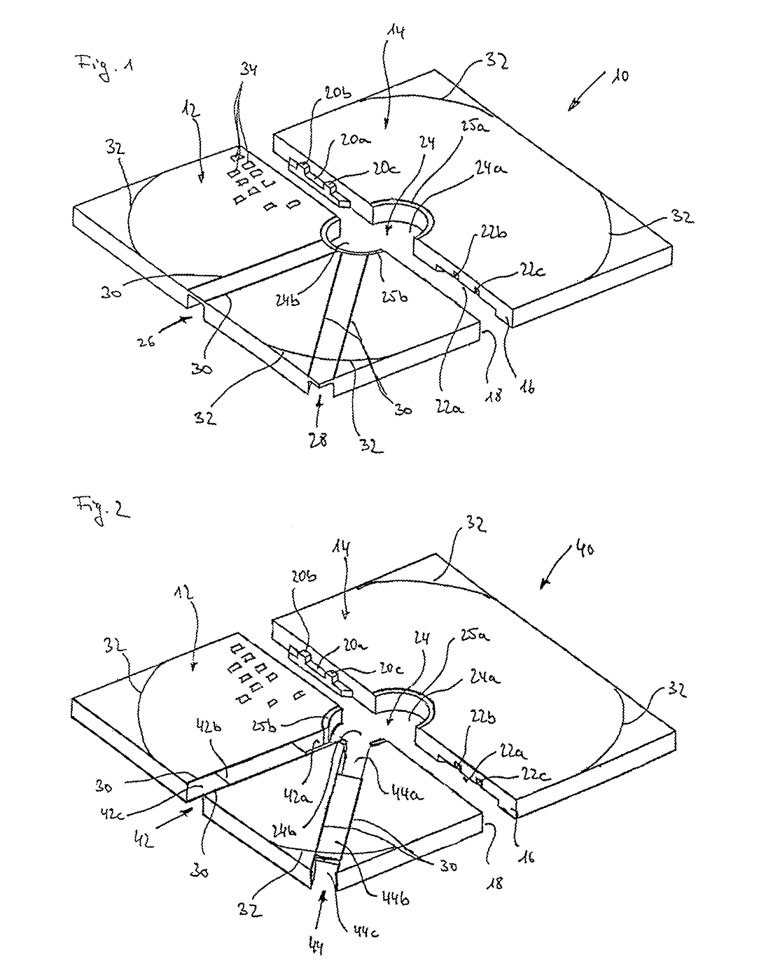

FIG. 1 a perspective view of a mounting plate according to a first embodiment of the present invention;

FIG. 2 a perspective view of a mounting plate according to a second embodiment of the present invention;

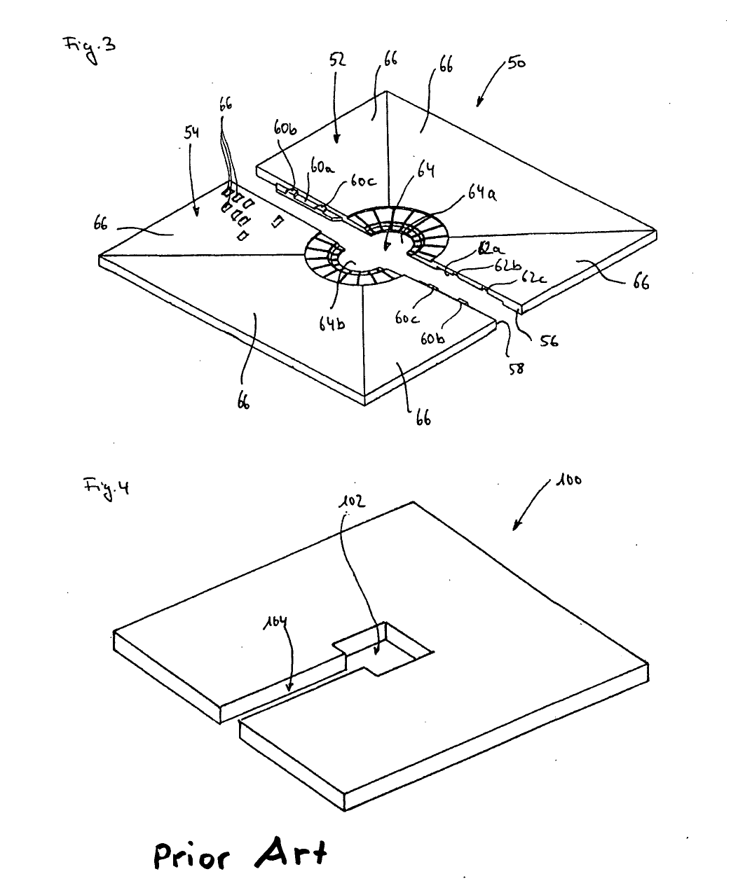

FIG. 3 a perspective view of a further mounting plate according to the present invention, and

FIG. 4 a perspective view of a known mounting plate.

The mounting plate 10 shown in FIG. 1 according to a first embodiment of the present invention is made up of two mounting plate segments 12 and 14 made of polystyrene which can be attached to one another releaseably. For this purpose connection means in the form of projections 20a, 20b, 20c and recesses 22a, 22b, 22c engaging with one another with a form fit are provided on the opposite abutting surfaces 16 and 18 of the respective mounting plate segments 12 and 14, in FIG. 1 only the connection means of the mounting plate segment 14 being visible. The two-part structure of the mounting plate 10 is advantageous to the effect that the mounting plate 10 can be easily handled, in particular transported and packaged.

The mounting plate segments 12 and 14 define together a circular housing recess 24 for accommodating a drain housing of a floor drain which is substantially cylindrical in form. For this purpose semi-circular recesses 24a and 24b are formed centrally on the opposing abutting surfaces 16 and 18. Furthermore, on the upper side of the mounting plate 10 semi-circular indentations 25a and 25b are provided which encompass the semi-circular recesses 24a and 24b. These indentations 25a and 25b serve to accommodate an annular support flange of the drain housing so that in the positioned state the upper side of this support flange ends substantially flush with the upper side of the mounting plate 10. Furthermore, by the support flange being accommodated in the indentations 25a and 25b, pre-determined positioning of the drain housing is achieved. Extending from the semi-circular recess 24b of the mounting plate segment 12 two pipe channels 26 and 28, open on one side, for accommodating a drain pipe of the floor drain are introduced into the mounting plate segment 12 which in this case are disposed at an angle of 45° in relation to one another. Correspondingly, the mounting plate 10 can either accommodate a drain pipe extending along the mounting plate diagonals in the tube channel 28, or a drain pipe extending along the plate bisector disposed at an angle of 45° in relation to the mounting plate diagonals in the pipe channel 26. Therefore, the mounting plate 10 can be used very variably. Furthermore, in order to strengthen the pipe channels 26 and 28 strengthening ribs, preferably formed as one part with the mounting plate and easy to remove, are provided, these not being shown in FIG. 1 however.

In order to facilitate total cutting free of the pipe channels 26 and 28 in order to produce a pipe channel 26 open on both sides or a pipe channel 28 open in both sides, cutting guide lines 30 are provided. Instead of the cutting guide lines 30, cutting guide indentations can also be formed. This cutting free can be necessary, for example, in cases where the height of one of the pipe channels 26 or 28 for accommodating a drain pipe is not sufficient, or where better accessibility should be provided for laying the pipe.

Furthermore, cutting guide lines 32, or alternatively cutting guide indentations are provided on the upper side of the mounting plate 10 which define a cutting pattern for producing a substantially round mounting plate 10 by means of sawing or cutting.

Moreover, distributed on both sides of the mounting plate 10 there are a plurality of small indentations 34 which are only shown suggestively. These indentations 34 are used as adhesion-promoting means for supporting the adhesion and/or clinging of a mortar or adhesive on the mounting plate 10.

It should be clear that instead of two pre-fabricated pipe channels 26 and 28, just a single pipe channel or more than two pipe channels can also be provided. Furthermore, it should be clear that the mounting plate segment 14 can also be replaced by a mounting plate segment which is identical in design to the mounting plate segment 12.

FIG. 2 shows a mounting plate 40 according to a second embodiment of the present invention. The mounting plate 40 only differs from the mounting plate 10 shown in FIG. 1 in the design of the pipe channels 42 and 44 formed in the mounting plate segment 12. In contrast to the pipe channels 26 and 28 of the mounting plate 10, the pipe channels 42 and 44 of the mounting plate 40 respectively have a pipe channel section 42a, 44a extending from the housing recess 24, which is open on both sides, a pipe channel section 42b, 44b connected to the latter, which is only open on one side, and in turn a pipe channel section 42c, 44c which is open on both sides. The length of the pipe channel sections 42a, 44a open on both sides has dimensions such that pipe connection points can be positioned within the latter, and so are easily accessible. On the one hand, in this way fitting of the floor drain is facilitated. On the other hand a larger space is also made available for accommodating the connection points which are normally larger than the diameter elsewhere on the drain pipe. As with the first embodiment illustrated in FIG. 1, the pipe channels 42 and 44 can also be strengthened with strengthening ribs, which can preferably easily be removed, the latter not being shown here however.

FIG. 3 shows a further mounting plate 50 according to the present invention. The mounting plate 50 is made up of two mounting plate segments 52 and 54 made of polystyrene which can be attached to one another releaseably. For this purpose connection means in the form of projections 60a, 60b, 60c and recesses 62a, 62b, 62c engaging with one another with a form fit are provided on the opposing abutting surfaces 56 and 58 of the mounting plate segments 52, 54. The two mounting plate segments 52 and 54 together define a circular passage opening 64 for accommodating a component of a floor drain designed like a pipe. In order to form the passage opening 64 semi-circular recesses 64a, 64b are respectively formed centrally on the abutting surfaces 56 and 58. The semi-circular recesses 64a and 64b are encompassed by semi-circular indentations 65a and 65b formed on the upper side of the mounting plate 50 which serve to accommodate a support flange of a further component of the floor drain. The surfaces of the two semi-circular indentations 65a and 65b are respectively provided with a plurality of ribs 65c which during fitting support the formation of a defined mortar or adhesive layer thickness.

In order to produce an incline towards the passage opening 64 the upper side of the mounting plate 50 is split into a number of substantially triangular surfaces 66 inclined downwards towards the passage opening 64. The structure of the mounting plate 50 shown in FIG. 3 is particularly advantageous to the effect that due to it being split into two mounting plate segments 52 and 54, the mounting plate 50 is less cumbersome, and so better to handle, in particular to transport and package.

The upper side of the mounting plate 50 can be provided with a sealing material, for example in the form of a sealing material in the form of a strip which is attached to the upper side of the mounting plate 50, or in the form of a coating material which is applied to the upper side of the mounting plate 50 (not shown in FIG. 3).

Moreover, a plurality of small indentations 66, which are only shown suggestively, are distributed over both sides of the mounting plate 50. These indentations 66 serve as adhesion-promoting means for supporting the adhesion and/or clinging of a mortar or adhesive to the mounting plate 50.

The mounting plate 50 is fitted either on its own or together with one of the mounting plates 10 and 40 shown in FIGS. 1 and 2. For the latter case the mounting plates 10 and 50 or the mounting plates 40 and 50 can be combined to form a mounting plate set.

### LIST OF REFERENCE NUMBERS

10 Mounting plate
12 Mounting plate segment
14 Mounting plate segment
16 Abutting surface
18 Abutting surface
20 a, b, c, d Projection
22 a, b, c Recess
24 Housing recess
24 a, b Semi-circular recess
25a, b Indentation
26 Pipe channel
28 Pipe channel
30 Cutting guide line
32 Cutting guide line
34 Indentation
40 Mounting plate
42 Pipe channel
42 a, b Pipe channel section
44 Pipe channel
44 a, b Pipe channel section
50 Mounting plate
52 Mounting plate segment
54 Mounting plate segment
60 a, b, c Projection
62 a, b, c Recess
64 Passage opening
65a, b Indentation
65c Rib
66 Indentation
100 Mounting plate
102 Housing recess
104 Pipe channel

1. A mounting plate (10) for the laying of a floor drain which has at least one drain housing and a drain pipe to be connected to the latter, comprising a pre-fabricated housing recess (24) for accommodating the drain housing, and at least one pre-fabricated pipe channel (26, 28; 42, 44) extending from the housing recess (24) for accommodating the drain pipe, wherein the at least one pipe channel (26, 28; 42, 44) is open at least partially on just one side.

2. The mounting plate (10) according to claim 1, wherein at least one strengthening rib is provided in order to strengthen the pipe channel (26, 28; 42, 44).

3. The mounting plate (10) according to claim 1, wherein the housing recess (24) is open on both sides.

4. The mounting plate (10) according to claim 1, wherein on its upper side an annular indentation (24a, 24b) enclosing the housing recess (24) is provided for accommodating a support flange of the drain housing.

5. The mounting plate (10) according to claim 1, wherein the at least one pipe channel (42, 44) has a channel section (42a, 44a) extending from the housing recess open on both sides.

6. The mounting plate (10) according to claim 5, wherein as regards its length, the channel section (42a, 44a), open on both sides, has dimensions such that the connection point between the drain housing and the drain pipe is accessible.

7. The mounting plate (10) according to claim 1, wherein at least two pre-fabricated pipe channels (26, 28; 42, 44) are provided.

8. The mounting plate (10) according to claim 7, wherein the two pipe channels (26, 28; 42, 44) are disposed at an angle of 90° or less, in particular approximately 45°,in relation to one another.

9. The mounting plate (10) according to claim 1, wherein cutting guide lines (30) and/or cutting guide indentations are provided in order to facilitate manual cutting free of the at least one pipe channel (26, 28; 42, 44).

10. The mounting plate (10) according to claim 1, wherein the latter has a polygonal outer contour.

11. The mounting plate (10) according to claim 10, wherein cutting guide lines (32) and/or indentations are provided in order to facilitate manual cutting out of an outer contour differing from a rectangular outer contour, in particular of a round or elliptical outer contour.

12. The mounting plate (10) according to claim 1, wherein at least one surface of the mounting plate (10) is provided with adhesion-promoting means which support adhesion and/or clinging of a mortar or adhesive to the upper side.

13. The mounting plate (10) according to claim 12, wherein indentations (34) are provided as adhesion-promoting means.

14. The mounting plate (10) according to claim 1, wherein the latter is split into a number of separate mounting plate segments (12, 14), in particular into two mounting plate segments (12, 14).

15. The mounting plate (10) according to claim 14, wherein the mounting plate segments (12, 14) have substantially the same dimensions.

16. The mounting plate (10) according to claim 15, wherein the mounting plate segments (12, 14) are designed identically.

17. The mounting plate (10) according to claim 14, wherein just one of the mounting plate segments (12) has one or more pipe channels (26, 28; 42, 44).

18. The mounting plate (10) according to claim 14, wherein the abutting surfaces (16, 18) of the mounting plate segments (12, 14) are provided with connection means (20a, b, c, 22a, b, c) which serve to attach adjacent mounting plate segments (12, 14) to one another.

19. The mounting plate (10) according to claim 18, wherein the connection means (20a, b, c, 22a, b, c) engage with one another with a form fit.

20. The mounting plate (10) according to claim 1, wherein the latter is made at least partially of a solid foam, in particular polystyrene.

21. A mounting plate set comprising at least one mounting plate according to claim 1, and at least one second mounting plate (50) which has a pre-fabricated passage opening (64) for accommodating a component of the floor drain, designed like a pipe, and an upper side provided with an incline towards the passage opening.

22. The mounting plate set according to claim 21, wherein the second mounting plate (50) is split into a number of separate mounting plate segments (52, 54), in particular into two mounting plate segments (52, 54).

23. The mounting plate set according to claim 22, wherein the mounting plate segments (52, 54) of the second mounting plate (50) have substantially the same dimensions.

24. The mounting plate set according to claim 22, wherein the mounting plate segments (52, 54) of the second mounting plate (50) are designed identically.

25. The mounting plate set according to claim 21, wherein the abutting surfaces (56, 58) of the mounting plate segments (52, 54) of the second mounting plate (50) are provided with connection means (60a, b, c; 62a, b, c) which serve to attach adjacent mounting plate segments (52, 54) to one another.

26. The mounting plate set according to claim 25, wherein the connection means (60a, b, c; 62a, b, c) engage with one another with a force fit.

27. The mounting plate set according to claim 21, wherein at least one surface of the second mounting plate (50) is provided with adhesion-promoting means which support adhesion and/or clinging of a mortar or adhesive onto the upper side.

28. The mounting plate set according to claim 27, wherein indentations (66) are provided as adhesion-promoting means.

29. The mounting plate set according to claim 21, wherein the upper side of the second mounting plate (50) is provided with a sealing material.

30. The mounting plate set according to claim 21, wherein on its upper side the second mounting plate (50) is provided with an annular indentation (65a, 65b) which surrounds the passage opening (64).

31. The mounting plate set according to claim 30, wherein on the upper side of the annular indentation (65a, 65b) ribs (65c) are formed which during fitting support the formation of a defined mortar or adhesive layer thickness.

32. The mounting plate (50) according to claim 19, wherein the latter is made at least partially of solid foam, in particular polystyrene.
